(19) United States
(12) Patent Application Publication
(10) Pub. No.: US 2007/0245061 A1
(43) Pub. Date: Oct. 18, 2007

(54) Multiplexing a parallel bus interface and a flash memory interface

(75) Inventor: David Harriman, Portland, OR (US)

Correspondence Address: INTEL CORPORATION;c/o INTELLEVATE, LLC, P.O. BOX 52050, MINNEAPOLIS, MN, 55402, US

(73) Assignee: INTEL CORPORATION

(21) Appl. No.: 11/404,170

(22) Filed: Apr. 13, 2006

(51) Int. Cl. G06F 12/00; G06F 13/14

(52) U.S. Cl. 711/100; 710/305

(57) ABSTRACT

Embodiments of the invention are generally directed to systems, methods, and apparatuses for multiplexing a parallel bus interface with a flash memory interface. In some embodiments, an integrated circuit includes a parallel bus interface to communicate parallel bus interface signals. The integrated circuit may also include logic to multiplex flash memory device interface signals and parallel bus interface signals on the parallel bus interface.

### TECHNICAL FIELD

Embodiments of the invention generally relate to the field of integrated circuits and, more particularly, to systems, methods and apparatuses for multiplexing a parallel bus interface with a flash memory interface.

### BACKGROUND

The availability of relatively large (e.g., in the range of gigabytes) NAND flash components makes their use attractive for hard disk augmentation and/or replacement. A NAND flash component refers to a flash component that uses NAND logic gates in its storage cells. These large NAND flash components also have the potential to be used in other ways such as the replacement of existing Basic Input/Output System (BIOS) flash devices.

The platform chipset (and/or the host processor) provides one possible attach point for NAND flash components in computing systems. Unfortunately, current NAND flash interfaces are relatively wide parallel interfaces that consume a large number of (expensive) pins. For example, current NAND flash interfaces typically require from (approximately) 15 to more than 40 pins. A very rough rule of thumb is that each pin costs approximately $0.02. In many cases, adding between 15 and 40 pins to, for example, an input/output controller (or another chip in a chipset) is cost prohibitive. Even at a fraction of this cost, the incremental cost of adding pins to the chipset for a NAND flash component is undesirable.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram illustrating selected aspects of a computing system capable of multiplexing a parallel interface and flash memory interface, according to an embodiment of the invention.

FIG. 2 is a block diagram illustrating selected aspects of a computing system having two channels of flash memory, according to an embodiment of the invention.

FIG. 3 is a block diagram illustrating selected aspects of a computing system in which each channel of flash memory includes two or more stacked flash memory devices.

FIG. 4 is a timing diagram illustrating selected aspects of multiplexing peripheral component interconnect (PCI) interface signals with flash memory interface signals according to an embodiment of the invention.

FIG. 5 is a flow diagram illustrating selected aspects of a method for multiplexing parallel bus interface signals with flash memory interface signals according to an embodiment of the invention.

FIG. 6 is a block diagram illustrating selected aspects of an electronic system according to an embodiment of the invention.

FIG. 7 is a bock diagram illustrating selected aspects of an electronic system according to an alternative embodiment of the invention.

### DETAILED DESCRIPTION

Embodiments of this invention allow a chipset to integrate a flash memory interface (at virtually no increase in pin cost) by multiplexing selected interface signals over an existing parallel bus interface. In some embodiments, the flash memory interface signals are multiplexed over an existing peripheral component interface (PCI). In such embodiments, one or more PCI devices and one or more NAND flash devices may be connected to the same bus. A chipset may dynamically select whether the PCI devices or the NAND flash devices have access to the bus. In alternative embodiments, the selection can be made statically such that either PCI devices or NAND flash devices may be used but one system cannot use both.

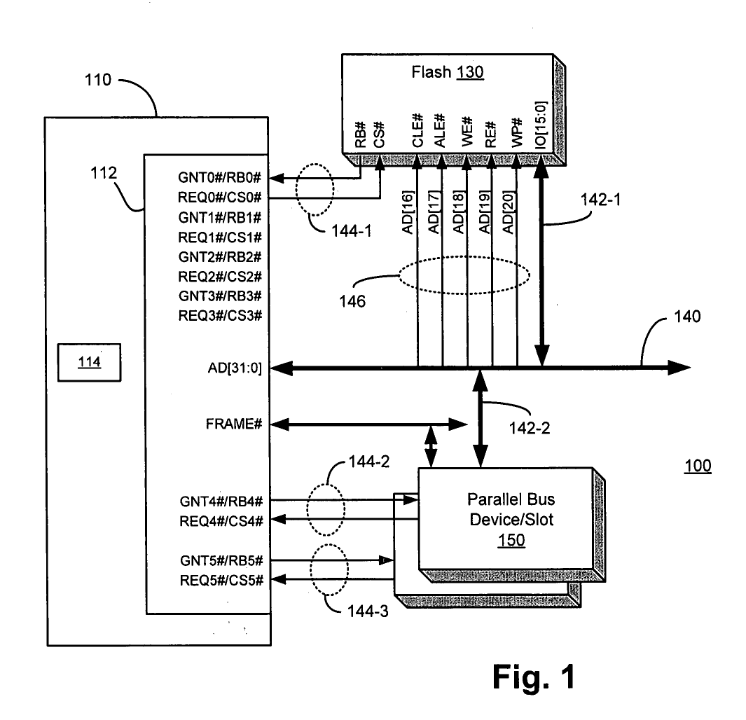

FIG. 1 is a block diagram illustrating selected aspects of a computing system capable of multiplexing flash memory interface signals over a parallel bus interface, according to an embodiment of the invention. System 100 includes integrated circuit 110, flash memory device 130, parallel bus 140, and parallel bus device/slot 150. In alternative embodiments, system 100 may include more, fewer, and/or different elements.

In some embodiments, integrated circuit 110 is part of a computing system's chipset. For example, integrated circuit 110 may be an input/output (I/O) controller (e.g., an I/O controller hub or a southbridge). An “I/O controller” refers to circuitry that monitors operations and performs tasks related to receiving input and transferring output for a computing system.

Integrated circuit 110 includes parallel bus interface 112. Parallel bus interface 112 provides an interface for parallel bus 140. For example, parallel bus interface 112 may include address, data, control, and/or general purpose pins as well as circuitry to drive these pins. In some embodiments, parallel bus interface 112 is a PCI interface. In alternative embodiments, parallel bus interface 112 may be an interface for a different parallel bus such as a parallel advanced technology attachment (PATA) bus.

Integrated circuit 110 also includes logic 114. In some embodiments, logic 114 arbitrates access to parallel bus interface 112. For example, in some embodiments, logic 114 may dynamically select whether flash memory device 130 or parallel bus device/slot 150 has access to shared parallel bus 140. In alternative embodiments, logic 114 may reference static configuration information (e.g., a fuse) to determine which device has access to parallel bus 140 and what kind of signaling (e.g., parallel bus interface and/or flash interface) is appropriate. In some embodiments, logic 114 is integrated with (and/or augments) a PCI arbiter.

Parallel bus device/slot 150 is a device (or a slot) that communicates with integrated circuit 110 using parallel bus interface signals. In some embodiments, system 100 may have a number of parallel bus devices (or slots) 150. Parallel devices/slots 150 may be devices embedded into a circuit board and/or slots into which parallel bus boards may be inserted. In some embodiments, parallel bus device/slots 150 are PCI devices (or slots).

Parallel bus 140 is a parallel bus implemented according to a parallel bus specification such as the PCI Specification. The “PCI Specification” refers to any of the PCI specifications including, for example, the PCI Local Bus Specification Revision 3.0. In some embodiments, parallel bus 140 includes shared I/O lines (e.g., for addresses and data) as well as control lines that are specific to a device (or to a slot). For example, in the illustrated embodiment, shared I/O lines 142 include a number of address and data lines that may be shared among a number of devices (or slots). Control lines 144, in contrast, illustrate pairs of REQx#/GNTx# lines that control a given device/slot.

Flash memory device 130 is a non-volatile memory component implemented using flash technology. In some embodiments, flash memory device 130 is a NAND flash memory device. Flash memory device 130 is coupled with parallel bus 140. In some embodiments, the I/O pins of flash memory device 130 are coupled with (at least some of) the address/data (AD) lines of parallel bus 140. In addition, a selected subset of the control signals (e.g., 146) for flash memory device 130 may be coupled with at least some of the AD lines of parallel bus 140. In some embodiments, another selected subset of the control signals (e.g., 141-1) for flash memory device 130 are coupled with control pins of interface 112. The term “pin” as used herein refers to a wide range of electrical connections to an integrated circuit and is not limited to connections having a particular shape.

An exemplary embodiment of the invention in which parallel bus 140 is a PCI bus and interface 112 is a PCI interface is now discussed with reference to FIG. 1. In such an embodiment, each device/slot coupled with PCI bus 140 may use a separate pair of REQ#/GNT# signals. For example, flash memory device 130 uses REQ#0/GNT#0 and PCI device/slot 150 uses REQ#4/GNT#4. In the illustrated embodiment, flash memory device 130 is a 16-bit flash memory device with I/O pins that are coupled with 16 of the AD lines of PCI bus 140 (e.g., as shown by 142-1). Optionally, one or more PCI devices may also be coupled with the AD lines of PCI bus 140 (e.g., as shown by 142-2).

Table 1 provides a description of the interface according to an embodiment of the invention. The embodiment shown in FIG. 1 (and described in Table 1) is merely an illustrative example of an embodiment. In alternative embodiments, the specific pins selected for multiplexing can be changed. In some embodiments, it may be desirable to select specific pins to optimize motherboard layout.

TABLE 1

| | | PCI | |
|---|---|---|---|
| Flash Component | | Interface | |
| Signal | Direction | Signal | Comment |
| Ready/Busy (RB#) | → | REQx# | Signal is open drain - Bias inside |
| | | | chipset or on motherboard |
| Chip Select (CS#) | [symbol] | GNTx# | Note that a single flash component |
| | | | may include more than one chip select - |
| | | | however they are wired within the |
| | | | flash component to work as if two |
| | | | separate flash chips. For this case |
| | | | simply use a corresponding number of |
| | | | GNTx# pins |
| Command Latch | [symbol] | AD[16] | These control signals are driven by |
| Enable (CLE#) | | | integrated circuit 110 when chip select |
| | | | is active; Note that selection of |
| | | | specific AD[x] is arbitrary. |
| Address Latch | [symbol] | AD[17] | See above |
| Enable (ALE#) | | | |
| Write Enable (WE#) | [symbol] | AD[18] | See above |
| Read Enable (RE#) | [symbol] | AD[19] | See above |
| Write Protect (WP#) | [symbol] | AD[20] | See above. Note that in some |
| | | | embodiments this signal may not be |
| | | | suitable for multiplexing - a general |
| | | | purpose IO pin or a GNTx# pin may |
| | | | used to drive the signal in these cases. |
| IO[15:0] (muxed | [symbol] | AD[15:0] | Bidirectional. May require integrated |
| address/cmd bus) | | | circuit 110 to separate the |
| | | | drive/tristate signals for its PCI |
| | | | buffers for these signals from those |
| | | | used for the control signals listed |
| | | | above. |

The embodiment shown in FIG. 1 (and described in part in Table 1) shows a single flash memory channel. In some embodiments, however, there are enough pins available on PCI bus 140 to allow two or more (potentially independent) channels. For example, in one embodiment there may be two channels, where one of the two channels may have a 16 bit I/O bus and the other may have an 8 bit I/O bus. The control signals for these channels may be multiplexed or they may be kept separate using, for example, an additional general purpose I/O pin.

Specific details about the PCI interface protocol and also various flash interface protocols are well documented elsewhere and are beyond the scope of this document. It should be noted, however, that the PCI Specification explicitly permits repurposing of the AD signals provided that the PCI control signals (including FRAME#, TRDY#, IRDY#, GNT#, etc.) are driven inactive.

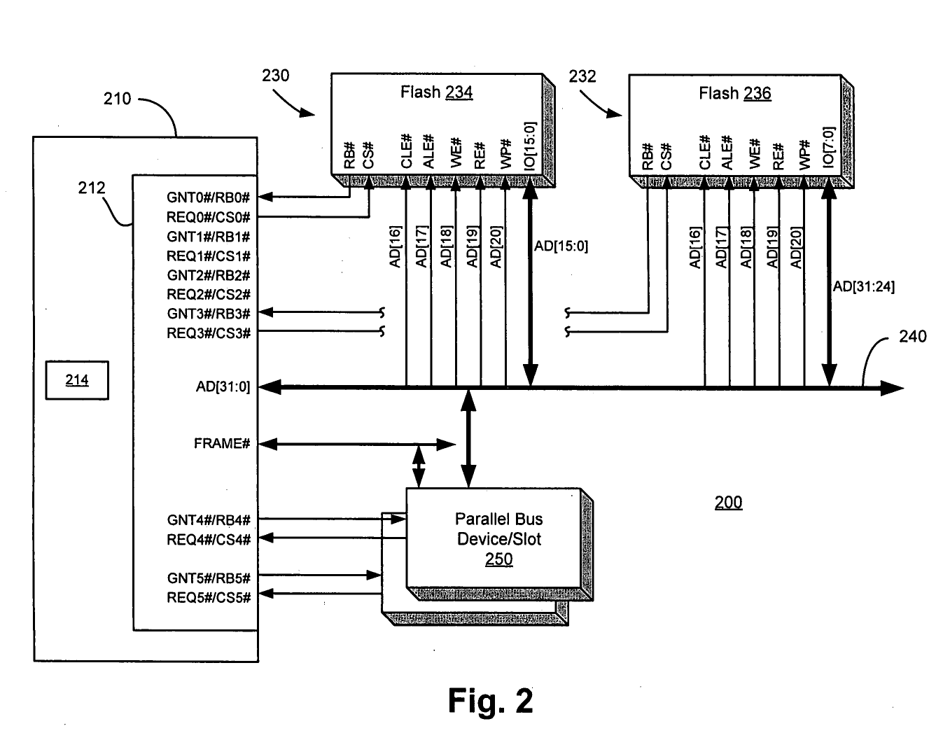

FIG. 2 is a block diagram illustrating selected aspects of a computing system having two channels of flash memory, according to an embodiment of the invention. System 200 includes I/O controller 210, flash memory channels 230-232 (respectively having flash memory devices 234-236), PCI bus 240, and PCI devices (or slots) 250. In an alternative embodiment, system 200 may have more, fewer, and/or different elements.

I/O controller 210 includes PCI interface 212 and logic 214. PCI interface 212 includes a number of pins and related circuitry (e.g., drivers, etc.) to couple I/O controller 210 to PCI bus 240. In some embodiments, a NAND flash memory interface is multiplexed over PCI interface 212. Logic 214 may selectively control whether PCI interface 212 is used for the flash memory interface or the PCI interface. In some embodiments, the selection is performed dynamically and, in other embodiments, the selection is performed statically.

Flash memory channels 230 and 232 provide separate non-volatile memory channels for system 200. In some embodiments, flash memory channels 230 and 232 are independent of each other. In alternative embodiments, at least some of the flash memory channel control signals for the two channels are multiplexed over the same lines of PCI bus 240. In the illustrated embodiment, for example, the CLE#, ALE#, WE#, RE#, and WP# signals for each channel are multiplexed over AD[20:16]. FIG. 2 illustrates, however, that, for example, enough pins may be available to implement two independent channels in which one has a 16 bit I/O bus and the other has an 8 bit I/O bus.

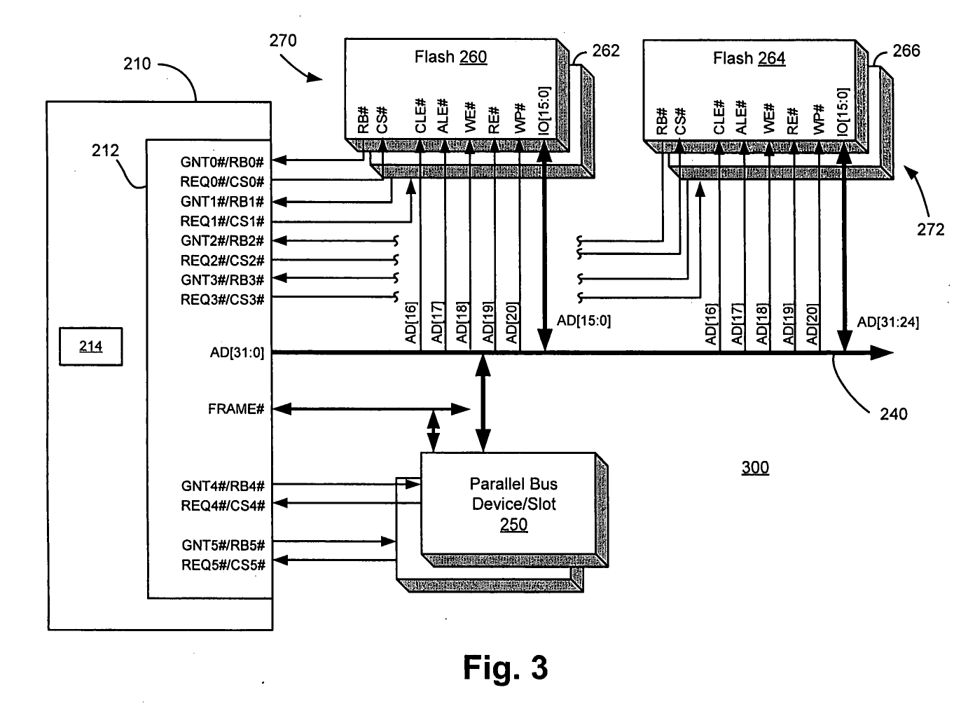

In some embodiments, at least one of the flash memory channels may include two or more flash memory devices. The term “stacked” refers to a memory channel having more than one flash memory device. The stacked flash devices may be combined within a single package or provided in separate packages. FIG. 3 is a block diagram illustrating selected aspects of a computing system in which each flash memory channel includes two or more stacked flash memory devices.

System 300 includes I/O controller 210, flash memory channels 270-272, and PCI bus 240. In the illustrated embodiment, each flash memory channel 270-272 includes two flash memory devices. For example, channel 270 includes flash memory devices 260 and 262. Similarly, channel 272 includes flash memory devices 264 and 266. In some embodiments, each pair of flash memory devices may be within a single package. For example, a single package of flash memory may have multiple pieces of silicon inside each providing a separate flash memory device. In some embodiments, the RB# and CS# pins are unique for each piece of silicon and the remaining pins may be bused. In alternative embodiments, channel 270 and/or channel 272 may include a different number of stacked flash memory devices.

FIG. 3 illustrates each flash memory channel (270-272) as having a pair of flash memory devices. In principle, flash memory channels 270-272 could have more than two flash memory devices. The limit on the number of flash memory devices is determined by electrical constraints. That is, there is a limit beyond which additional flash memory devices cannot be added because the incremental increase in electrical load on the pins that are shared is too great.

Table 2 provides a description of the interface according to an embodiment of the invention. The embodiment shown in FIG. 3 (and described in Table 2) is merely an illustrative example of an embodiment. In alternative embodiments, the specific pins selected for multiplexing can be changed. In some embodiments, it may be desirable to select specific pins to optimize motherboard layout.

TABLE 2

| | | PCI | |
|---|---|---|---|
| Flash Component | | Interface | |
| Signal | Direction | Signal | Comment |
| Ready/Busy (RB#) | → | REQx# | Signal is open drain - Bias inside |
| | | | chipset or on motherboard |
| Chip Select (CS#) | [symbol] | GNTx# | Note that a single flash component |
| | | | may include more than one chip select - |
| | | | however they are wired within the |
| | | | flash component to work as if two |
| | | | separate flash chips. For this case, |
| | | | simply use a corresponding number of |
| | | | GNTx# pins. |
| Command Latch | [symbol] | AD[16] | These control signals are driven by |
| Enable (CLE#) | | | integrated circuit 110 when chip select |
| | | | is active; Note that selection of |
| | | | specific AD[x] is arbitrary. |
| Address Latch | [symbol] | AD[17] | See above |
| Enable(ALE#) | | | |
| Write Enable (WE#) | [symbol] | AD[18] | See above |
| Read Enable (RE#) | [symbol] | AD[19] | See above |
| Write Protect (WP#) | [symbol] | AD[20] | See above. Note that in some |
| | | | embodiments this signal may not be |
| | | | suitable for multiplexing - a general |
| | | | purpose IO pin or a GNTx# pin may |
| | | | be used to drive the signal in these |
| | | | cases. |
| IO[7:0] (muxed | [symbol] | AD[7:0] | Bidirectional. May require integrated |
| address/cmd bus) | | | circuit 110 to separate the |
| | | | drive/tristate signals for its PCI |
| | | | buffers for these signals from those |
| | | | used for the control signals listed |
| | | | above. |
| IO[15:8] (muxed | [symbol] | AD[15:8] | See above. Note that, in some |
| address/cmd bus) | | | embodiments, the 8b bus is the |
| | | | minimum required but a component |
| | | | may have more than an 8b bus. |

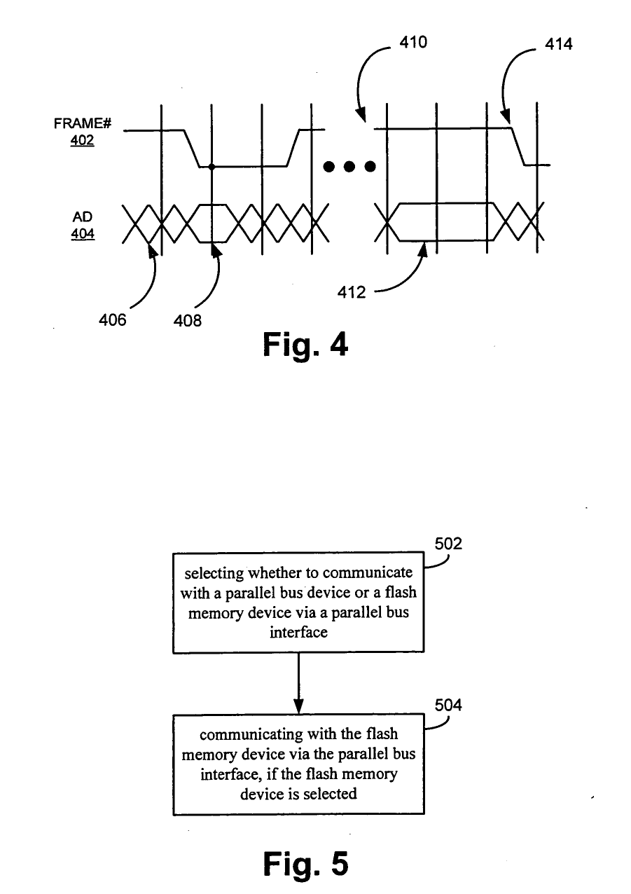

FIG. 4 is a timing diagram illustrating selected aspects of multiplexing PCI interface signals with flash memory interface signals according to an embodiment of the invention. Timing diagram 400 illustrates cycle frame (FRAME#) signal 402 and address/data (AD) bus 404. FRAME# 402 is driven by the component granted ownership of AD bus 404, and indicates the start of a cycle and before FRAME# 402 is asserted the value of the AD bus is “do not care” as shown by 406. Once FRAME# 402 is asserted, each PCI device coupled with the PCI bus (e.g., the parallel bus devices 250 shown in FIG. 3 that are coupled with PCI bus 240) samples AD bus 404 (e.g., during the address phase) to determine which device is being addressed as shown by 408. Subsequent to the address phase, AD bus 404 is used to transfer data for a period indicated by the continued assertion of FRAME# 402.

In some embodiments, AD bus 404 may address either a PCI device or a flash memory device. If AD bus 404 addresses a flash memory device, then that flash memory device may be granted control (at least temporarily) of the PCI bus. Referring to reference number 410, a flash memory device is in control of the PCI bus. The flash memory device conveys data (e.g., write data and/or read data) on AD bus 404 as shown by 412. At the conclusion of the flash memory transaction, in this example, FRAME# 402 is asserted and control of AD bus 404 may pass to another device (e.g., a PCI device).

FIG. 5 is a flow diagram illustrating selected aspects of a method for multiplexing parallel bus interface signals with flash memory interface signals according to an embodiment of the invention. Referring to process block 502, an integrated circuit such as an I/O controller selects whether to communicate with a parallel bus device or a flash memory device via a parallel bus interface. In some embodiments, the selection is performed dynamically. For example, the I/O controller may dynamically select whether a parallel bus device or a flash memory device is allowed to use the parallel bus interface (e.g., for given transaction, length of time, etc). In alternative embodiments, the selection is statically performed. That is, the I/O controller references an indicator (such as a fuse) to determine whether an interface can be used to communicate with a parallel bus device or a flash memory device. In some embodiments, the parallel bus is a PCI bus and the parallel bus interface is a PCI interface.

If the flash memory device is selected, then the I/O controller communicates with the flash memory device via the parallel bus interface as shown by 504. In some embodiments, the I/O controller communicates address and data signals to the flash memory device over one or more address/data lines of the parallel bus. The I/O controller may also communicate selected command signals with the flash memory device over dedicated command lines (e.g., a pair of REQ#/GNT# pins). In some embodiments, at least some of the command signals for the flash memory device are multiplexed over one or more of the address and data lines of the parallel bus.

In some embodiments, a number of considerations should be made when selecting an appropriate flash memory component. For example, in some embodiments, the selected flash memory component should be compatible with PCI signaling and should not interfere with the PCI components on the bus (if any). Table 3 lists a number of considerations according to an embodiment of the invention.

TABLE 3

| | |
|---|---|
| Voltage levels | Existing 3.3 V flash components |
| | may be suitable candidates. Note that |
| | a 5 V tolerance does not appear to |
| | be supported by flash components. |
| Edge Rates | Provided the I/O controller (e.g., |
| | the ICH) can support both PCI and |
| | flash interface requirements, it |
| | may not be necessary for the two to |
| | match. |
| Capacitance | The NAND flash will see a relatively |
| | large capacitive loading from the |
| | PCI bus. |
| Impedance | The inductive and resistive aspects |
| | of impedance are unlikely to present |
| | a problem and the capacitive component |
| | is noted above. |

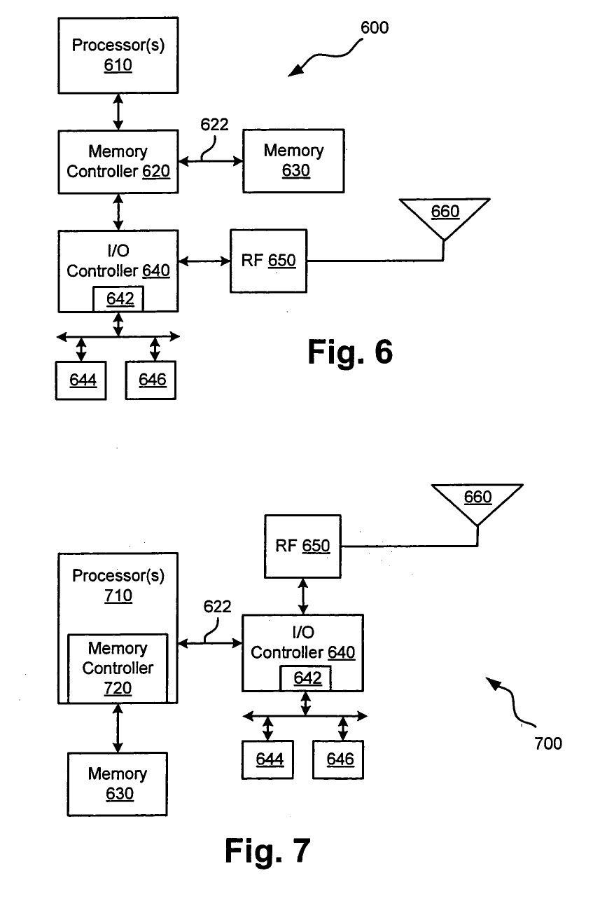

FIG. 6 is a block diagram illustrating selected aspects of an electronic system according to an embodiment of the invention. Electronic system 600 includes processor 610, memory controller 620, memory 630, input/output (I/O) controller 640, radio frequency (RF) circuits 650, and antenna 660. In operation, system 600 sends and receives signals using antenna 660, and these signals are processed by the various elements shown in FIG. 6. Antenna 660 may be a directional antenna or an omni-directional antenna. As used herein, the term omni-directional antenna refers to any antenna having a substantially uniform pattern in at least one plane. For example, in some embodiments, antenna 660 may be an omni-directional antenna such as a dipole antenna or a quarter wave antenna. Also, for example, in some embodiments, antenna 660 may be a directional antenna such as a parabolic dish antenna, a patch antenna, or a Yagi antenna. In some embodiments, antenna 660 may include multiple physical antennas.

Radio frequency circuit 650 communicates with antenna 660 and I/O controller 640. In some embodiments, RF circuit 650 includes a physical interface (PHY) corresponding to a communication protocol. For example, RF circuit 650 may include modulators, demodulators, mixers, frequency synthesizers, low noise amplifiers, power amplifiers, and the like. In some embodiments, RF circuit 650 may include a heterodyne receiver, and in other embodiments, RF circuit 650 may include a direct conversion receiver. For example, in embodiments with multiple antennas 660, each antenna may be coupled to a corresponding receiver. In operation, RF circuit 650 receives communications signals from antenna 660 and provides analog or digital signals to I/O controller 640. Further, I/O controller 640 may provide signals to RF circuit 650, which operates on the signals and then transmits them to antenna 660.

Processor(s) 610 may be any type of processing device. For example, processor 610 may be a microprocessor, a microcontroller, or the like. Further, processor 610 may include any number of processing cores or may include any number of separate processors.

Memory controller 620 provides a communication path between processor 610 and other elements shown in FIG. 6. In some embodiments, memory controller 620 is part of a hub device that provides other functions as well. As shown in FIG. 6, memory controller 620 is coupled to processor(s) 610, I/O controller 640, and memory 630.

Memory 630 may include multiple memory devices. These memory devices may be based on any type of memory technology. For example, memory 630 may be random access memory (RAM), dynamic random access memory (DRAM), static random access memory (SRAM), nonvolatile memory such as FLASH memory, or any other type of memory.

Memory 630 may represent a single memory device or a number of memory devices on one or more modules. Memory controller 620 provides data through interconnect 622 to memory 630 and receives data from memory 630 in response to read requests. Commands and/or addresses may be provided to memory 630 through interconnect 622 or through a different interconnect (not shown). Memory controller 630 may receive data to be stored in memory 630 from processor 610 or from another source. Memory controller 630 may provide the data it receives from memory 630 to processor 610 or to another destination. Interconnect 622 may be a bi-directional interconnect or a unidirectional interconnect. Interconnect 622 may include a number of parallel conductors. The signals may be differential or single ended. In some embodiments, interconnect 622 operates using a forwarded, multiphase clock scheme.

Memory controller 620 is also coupled to I/O controller 640 and provides a communications path between processor(s) 610 and I/O controller 640. I/O controller 640 includes circuitry for communicating with I/O circuits such as serial ports, parallel ports, universal serial bus (USB) ports and the like. As shown in FIG. 6, I/O controller 640 provides a communication path to RF circuits 650.

I/O controller 640 also includes parallel bus interface 642 (e.g., a PCI interface). In some embodiments, flash memory interface signals may be multiplexed over parallel bus interface 642. For example, in the illustrated embodiment, parallel bus interface 642 can selectively communicate with flash memory device 644 or parallel bus device (e.g., a PCI device) 646.

FIG. 7 is a bock diagram illustrating selected aspects of an electronic system according to an alternative embodiment of the invention. Electronic system 700 includes memory 630, I/O controller 640, RF circuits 650, and antenna 660, all of which are described above with reference to FIG. 6. Electronic system 700 also includes processor(s) 710 and memory controller 720. As shown in FIG. 7, memory controller 720 may be on the same die as processor(s) 710. Processor(s) 710 may be any type of processor as described above with reference to processor 610. Example systems represented by FIGS. 6 and 7 include desktop computers, laptop computers, servers, cellular phones, personal digital assistants, digital home systems, and the like.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. An integrated circuit comprising:
a parallel bus interface to communicate parallel bus interface signals; and
logic coupled with the parallel bus interface, the logic to multiplex non-volatile storage device interface signals with the parallel bus interface signals on the parallel bus interface.

2. The integrated circuit of claim 1, wherein the logic coupled with the parallel bus interface comprises:
logic to multiplex flash memory interface signals with the parallel bus interface signals on the parallel bus interface.

3. The integrated circuit of claim 2, wherein the logic to multiplex flash memory interface signals with the parallel bus interface signals on the parallel bus interface comprises:
logic to multiplex NAND flash interface signals with the parallel bus interface signals on the parallel bus interface.

4. The integrated circuit of claim 3, wherein the parallel interface is a peripheral component interconnect (PCI) interface to communicate PCI interface signals.

5. The integrated circuit of claim 4, wherein the logic to multiplex NAND flash interface signals with the PCI interface signals on the PCI interface comprises:
logic to dynamically multiplex NAND flash interface signals with the PCI interface signals on the PCI interface.

6. The integrated circuit of claim 4, wherein the logic to multiplex NAND flash interface signals with the PCI interface signals on the PCI interface comprises:
logic to statically configure whether the PCI interface communicates NAND flash interface signals or the PCI interface signals.

7. The integrated circuit of claim 4, wherein the PCI interface is to multiplex a ready/busy signal (RB#) and a request signal (REQx#) on a common pin.

8. The integrated circuit of claim 4, wherein the PCI interface is to multiplex a chip select signal (CS#) and a grant signal (GNTx#) on a common pin.

9. The integrated circuit of claim 1, wherein the integrated circuit includes an input/output controller.

10. A method comprising:
selecting whether to communicate with a parallel bus device or a flash memory device via a parallel bus interface; and
communicating with the flash memory device via the parallel bus interface, if the flash memory device is selected.

11. The method of claim 10, wherein the parallel bus device includes a peripheral component interconnect (PCI) device, the flash memory device includes a NAND flash device, and the parallel bus interface is a PCI interface.

12. The method of claim 11, wherein selecting whether to communicate with the parallel bus device or the flash memory device via the parallel bus interface comprises:
dynamically selecting whether to communicate with the parallel bus device or the flash memory device via the parallel bus interface.

13. The method of claim 11, wherein selecting whether to communicate with the parallel bus device or the flash memory device via the parallel bus interface comprises:
statically selecting whether to communicate with the parallel bus device or the flash memory device via the parallel bus interface.

14. The method of claim 11, wherein communicating with the NAND flash memory device via the PCI interface, if the NAND flash memory device is selected comprises:
multiplexing a ready/busy signal (RB#) on a request signal (REQx#) pin of the PCI interface; and
multiplexing a chip select signal (CS#) on a grant signal (GNTx#) pin of the PCI interface.

15. A system comprising;
a parallel bus having a plurality of input/output lines;
an integrated circuit coupled with the parallel bus, the integrated circuit including
a parallel bus interface to communicate parallel bus interface signals; and
logic coupled with the parallel bus interface, the logic to multiplex flash memory device interface signals with the parallel bus interface signals on the parallel bus interface; and
a flash memory device coupled with at least some of the plurality of input/output lines to provide a first memory channel.

16. The system of claim 15, wherein the parallel bus includes a peripheral component interconnect (PCI) bus and the parallel bus interface includes a PCI interface.

17. The system of claim 16, further comprising:
a second flash memory device coupled with at least some of the plurality of input/output lines to provide a second memory channel.

18. The system of claim 17, further comprising:
a third flash memory device coupled with the second flash memory device to increase a capacity of the second memory channel.

19. The system of claim 18, wherein the second flash memory device and the third flash memory device are collocated within a single package.

20. The system of claim 15, wherein the integrated circuit includes an input/output controller.
